(19) United States
(12) Patent Application Publication
(10) Pub. No.: US 2006/0032930 A1
(43) Pub. Date: Feb. 16, 2006

(54) Methods and apparatus for controlling baking oven zone temperature

(75) Inventor: James A. Glidden, Saginaw, MI (US)

Correspondence Address: McCulloch PLC;1st Floor, 5291 Colony Drive North, Saginaw, MI, 48603, US

(73) Assignee: BANNER ENGINEERING & SALES, INC.

(21) Appl. No.: 11/201,511

(22) Filed: Aug. 11, 2005

Related U.S. Application Data
(60) Provisional application No. 60/601,330, filed on Aug. 13, 2004.

(51) Int. Cl. F23N 1/00; F04B 41/06; G05D 23/02

(52) U.S. Cl. 236/15 A; 236/1 E; 236/1 EA

(57) ABSTRACT

Apparatus and methods for controlling temperature in a bakery oven zone wherein a predetermined temperature is selected and fuel and pressurized combustion air are supplied to burners in such zone. The fuel supplied is a function of the combustion air pressure which may be adjusted in response to the sensing of temperature variations and in such manner as to maintain the predetermined temperature in such zone substantially constant. The pressure of the combustion air also may be varied in such manner as to adjust the number of ignited burners in such zone.

### CROSS REFERENCE TO RELATED APPLICATIONS

This application claims the priority of U.S. Provisional Application No. 60/601,330, filed Aug. 13, 2004.

This invention relates to the controlling of temperature in a selected zone of a commercial bakery oven.

### BACKGROUND OF THE INVENTION

A commercial bakery oven conventionally has a housing having an inlet for receiving products to be baked and an outlet through which baked products are discharged from the oven. Within the oven housing is a conveyor by means of which products introduced to the oven via its inlet are conducted along a path to the outlet of the oven. The product path passes through one or more zones each of which has a plurality of fuel burners that extend transversely of the product path and are spaced longitudinally along the path. Fuel such as natural or propane gas is delivered to each of the burners along with combustion air under positive pressure. Fuel discharged through the burners is ignited and burned to produce and maintain heat in the zone or zones sufficient to bake the products. The heat produced by each burner is directly proportional to the quantity of the fuel consumed.

The temperature of each zone of the oven typically may be set to a predetermined level, known as a set point, at which the particular product is to be baked. Each zone of the oven also conventionally includes a temperature sensor by means of which the zone temperature, as well as variations in temperature, may be monitored. Conventionally, the temperature sensor is coupled to an adjustable control unit which, in turn, is coupled to the fuel delivery system so that, should the temperature in the zone rise to a level above that of the desired temperature, the supply of fuel to selected burners may be discontinued, thereby enabling, the temperature in the zone to be reduced. When the temperature falls to a level at or below that of the predetermined desired level, fuel again will be supplied to the previously shut off burners and the latter relighted to as to enable the temperature in the zone to rise, and hopefully, be maintained at the desired level.

The conventional oven zone temperature control system thus is one which relies primarily on shutting off and relighting selected burners solely in response to detected temperature deviations from a predetermined temperature level. Such a system is beset by many problems which result in inefficiencies and irregular temperature maintenance.

### SUMMARY OF THE INVENTION

Oven zone temperature control according to the invention is effected primarily by establishing a predetermined combustion air pressure and velocity for the fuel delivery system, setting a predetermined temperature level, sensing temperature variations from such level in one or more selected zones, and using such variations to effect adjustment of the pressure and velocity of combustion air supplied to the burners in such zone or zones, thereby enabling adjustment of the quantity of fuel supplied to the burners in such manner as to establish and maintain the zone temperature at the predetermined level.

If the temperature within a selected oven zone rises to a level above the predetermined desired level, then according to the invention the pressure of the combustion air is reduced. The arrangement is such that a reduction in pressure of the combustion air reduces, or completely shuts off, the quantity of fuel delivered to burners in the selected zone, thereby reducing the heat which is generated in such zone by the burners.

Conversely, should the temperature in a selected zone fall to a selected level below the predetermined level, the pressure of the combustion air will be increased, thereby resulting in an increase in the quantity of fuel delivered to each burner, relighting any shut off burner, and enabling greater heat to be generated in the zone.

A significant difference in an oven temperature control system according to the invention and the conventional oven temperature control system is that the control system according to the invention is based upon the use of variations in oven zone temperature to effect control of the combustion air pressure and the use of variations in combustion air pressure to control the fuel supply, whereas in the conventional control system only temperature variations are used to control the supply of fuel to the burners.

### THE DRAWINGS

Methods and apparatus according to the invention are described in the following specification and illustrated in the accompanying drawings wherein:

FIG. 1 is a schematic diagram of the presently preferred control system; and

FIG. 2 is a diagrammatic illustration of burner zone staging examples.

### THE DISCLOSED EMBODIMENT

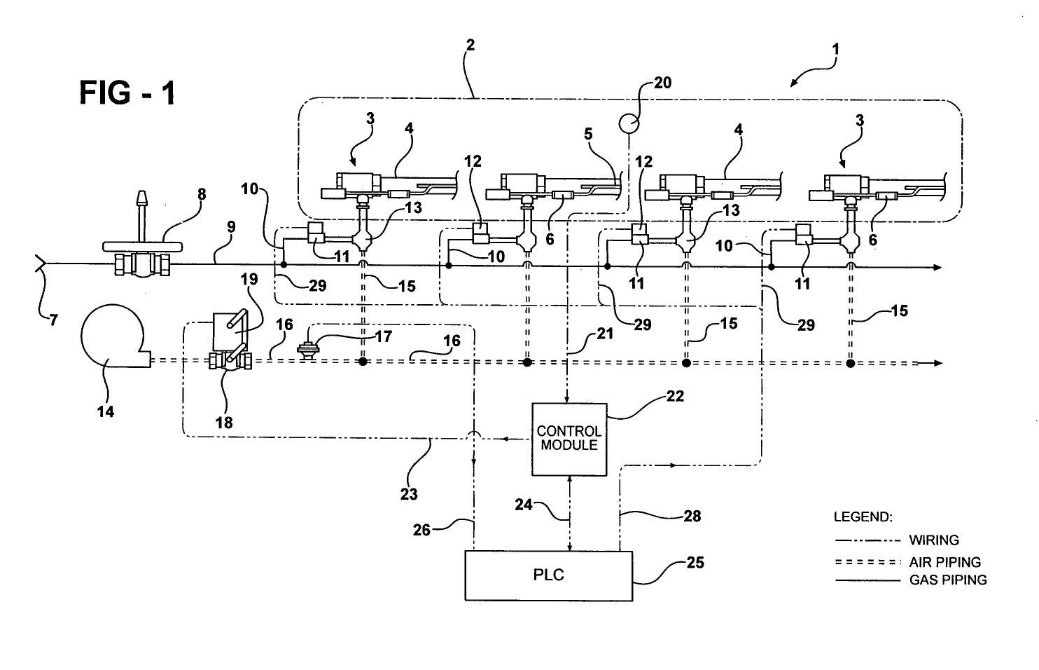

Control apparatus constructed in accordance with the invention is adapted for use in a commercial baking oven 1 of the kind having a housing 2 provided with a product inlet at one end, a finished product outlet at the opposite end, and a product conveyor mechanism (not shown) for conveying products along a path leading from the inlet end of the oven to the outlet thereof. The oven has a plurality of zones extending longitudinally of the product path. Only a part of one of such zones is shown in FIG. 1.

Mounted in each zone of the oven is a plurality of fuel burners 3 each of which includes a tube 4 having a ribbon outlet 5 through which fuel, such as natural or propane gas, may pass and be ignited by an ignitor 6 of known construction. The burners are spaced longitudinally along the product path and extend transversely of such path, as is conventional.

Each burner is connected to a source 7 of fuel via a known zero pressure regulator 8, a pipeline 9, a branch line 10, a gas cock 1 1, a gas cock control solenoid 12, and a gas/air venturi mixer 13. The fuel delivery components disclosed are conventional.

A source of combustion air under positive pressure is indicated at 14. Each venturi mixer 13 is coupled to the air source 14 via a passage 15, a flow line or header 16, a pressure transducer 17, and a butterfly flow control valve 18 which may be moved to any selected position between fully opened and fully closed by means of a reversible, electrically operable modulating motor 19 of known construction. Except for the pressure transducer 17 and parts associated exclusively therewith the illustrated combustion air delivery apparatus is conventional.

Mounted in each oven zone is an adjustable temperature sensor 20 of known construction for monitoring the temperature within the oven zone. The sensor 20 is connected via appropriate wiring 21 to a control module 22 of known construction which also is connected by wiring 23 to the modulating motor 19. The control module 22 also is coupled by appropriate wiring 24 to a programmable controller 25 of known construction which, in turn, is connected by wiring 26 to the pressure transducer 17 and to the solenoid 12 of each valve 11 by suitable wiring 28 and 29. The coupling 24 between the control module 22 and the programmable controller 25 is simply to enable the latter to receive and acknowledge information relating to temperature settings of the control module 22 entered into the controller 25. A suitable programmable controller 25 is one manufactured by Allen-Bradley of Milwaukee, Wis. and designated SLC-500.

The control module 22 is one that can be used to establish any selected one of a number of temperature set points or values. The arrangement is such that, following selection of a temperature set point, whenever a change in zone temperature is sensed by the sensor 20, a signal is transmitted to the control module 22 whereupon the latter will generate a signal that is transmitted via the connection 23 to the modulating motor 19. A suitable control module 22 is Model No. MLC 9000+ manufactured by West Instruments, Ltd., of Bighton, England.

In the operation of the apparatus, fuel gas (at zero pressure) from the supply 7 is coupled to each of the venturi mixers 13 via the valves 11, and the control module 22 is set to the predetermined temperature level or set point. Combustion air at a predetermined pressure is delivered to each of the venturi mixers 13 via the valve 18, the header 16, and the respective passages 15. As combustion air flows through a venturi mixer 13 it will entrain fuel at a rate consistent with the air velocity which is directly proportional to the air flow through the valve 18. Fuel discharged from each burner 3 will be ignited so as to generate heat in the oven zone.

Any variation in zone temperature from the predetermined level, within a selected variation range, will be sensed by the temperature sensor 20 and transmitted via the connection 21 to the control module 22 which, in turn, will transmit a signal via the connection 23 to the modulating motor 19, thereby effecting adjustment of the valve 18 so as to increase or decrease the velocity and pressure of the combustion air flowing to the venturi mixers 13.

If, for example, the sensor 20 detects an increase above the predetermined level of the temperature of the oven zone an appropriate signal will be transmitted to the control module 22 so as rapidly to effect energization of the modulating motor 19 to effect partial closing of the valve 18. This immediately will result in a reduction of combustion air pressure in the header 16 which will be detected by the transducer 17. A reduction in the pressure and, consequently, a reduction in the velocity of the combustion air delivered to the venturi mixers 13 will result in a reduction in fuel being delivered to the burners 3. The reduction in the flow of fuel to the burners will lower the heat generated by the burners, thereby lowering the temperature in the oven zone.

Depending on the magnitude of the combustion air pressure decrease, as detected by the transducer 17, the controller 25 will generate and transmit a signal to a selected number of fuel cock solenoids 12 to actuate and close the associated fuel cocks 11, thereby shutting off the associated burners 3 and reducing the heat generated in the zone. The burner or burners shut off may be randomly selected by the controller 25. The shutting off of one or more burners in a zone is known as staging down.

Conversely, if the temperature sensor 20 detects the lowering of the zone temperature from the set point temperature, a signal will be sent from the sensor 20 to the control module 22 which will energize the modulating motor 19 to effect opening of the valve 18 resulting in an increase in the flow of combustion air through the valve 18, the header 16, and the passages 15 so as to increase the velocity of air supplied to the venturi mixers 13, thereby increasing the quantity of fuel supplied to the burners and enabling a greater quantity of heat to be generated. The increase in air pressure in the header 16 will, be detected by the transducer 17, thereby generating a signal to the controller 25.

Depending on the magnitude of the increase in combustion air pressure, as detected by the transducer 17, the controller 25 will transmit a signal to the selected solenoids 12 and energize them to open at least some of the previously closed cocks 11, thereby enabling the corresponding shut off burners to be relighted.

By including the pressure transducer 17 and the controller 25 in the system, temperature fluctuations of such magnitude as to make desirable staging burners off and on in a zone can be effected extremely rapidly, thereby enabling control over oven zone temperature to be obtained more quickly and with much greater precision than previously has been possible.

The ability of the transducer 17 to detect virtually instantaneously a variation in the pressure of combustion air flowing through the header 16, and the coupling between the transducer and the controller 25 make it possible for the latter to react to any variation from the selected predetermined combustion air pressure. Should the air pressure increase above a predetermined level, as set in the controller 25, the latter instantly will generate a signal which will be transmitted to one or more gas cock control solenoids 12 to shut off the associated cocks 11, thereby staging down the affected oven zone by turning off one or more of the burners in such zone.

Following staging down of an oven zone it is possible that the temperature in such zone will fall below a predetermined level. If so, the temperature sensor 20 will transmit the appropriate signal to the control module 22 which, in turn, will send a signal to the modulating motor 19 and open the valve 18 to increase the flow of combustion air through such valve into and through the header 16, the passages 15, and the venturi mixers 13 to the burners 3. The increase in air pressure in the headers 16 will be detected by the transducer 17 which will send a signal to the controller 25 and, if appropriate, energize the solenoids 12 and open the previously closed fuel cocks 11, thereby enabling fuel to be resupplied to the burners 3. Such fuel will be ignited by the ignitors 6, thereby enabling the zone temperature to increase.

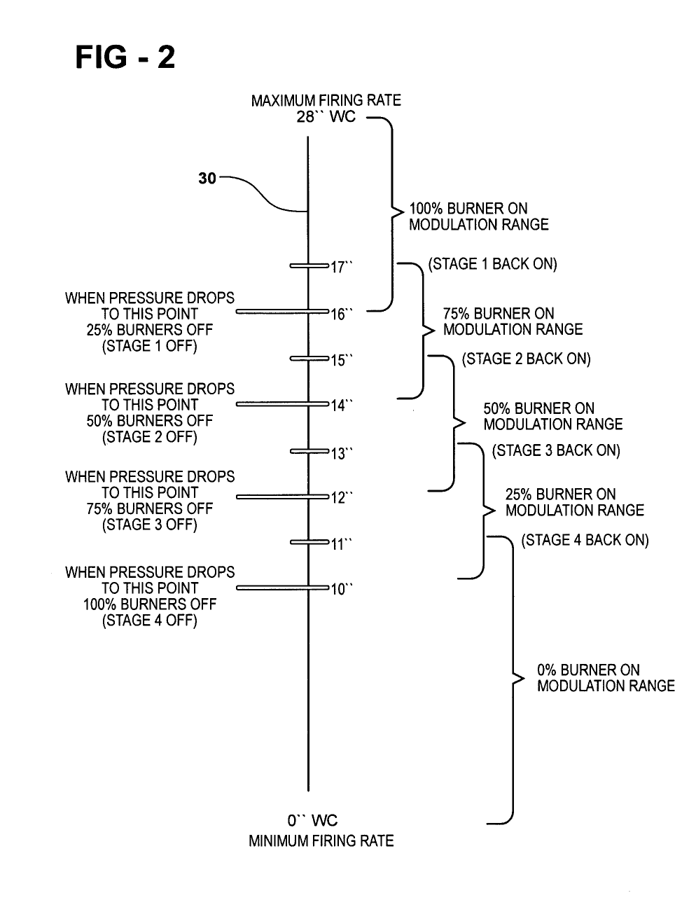

Typical operations of the apparatus are illustrated in FIG. 2 wherein a vertical line 30 represents combustion air pressure, in inches of water column; the horizontal, vertically spaced single lines represent certain pressure levels; and the horizontal double lines represent other predetermined pressure levels (in inches).

The single lines represent, in vertically ascending order, 10, 12, 14, and 16 inches of pressure, respectively, and the double lines represent 11, 13, 15, and 17 inches of pressure, respectively.

The area at and near the top of the vertical line 30 (representing 28 inches of water column pressure) designates the maximum firing rate of the burners, i.e., when all burners in a zone are ignited, whereas the area below 10 inches of pressure is designated the minimum firing rate, i.e., when no burners, or fewer of them than can operate with stability, are ignited.

If it is assumed that the temperature set point is 450° F., and that 100% of the burners in a selected oven zone are to operate when the combustion air pressure in the header 16 is at a pressure of 16 inches, all burners will be ignited when the pressure is at or greater than 16 inches. Should the temperature start to rise to a level higher than the selected set point of 450°, the change in temperature will be sensed by the sensor 20 and the modulating motor 19 operated to reduce the combustion air pressure in the header 16. As has been explained, the reduction in air pressure will effect a reduction in the velocity at which combustion gas flows through the venturi mixers 13, thereby reducing the fuel flow to the burners 3 and lowering the zone temperature. Should the pressure fall below 16 inches, the transducer 17 will send the appropriate signal to the controller 25 which will function to close a selected number of fuel cocks 11 and thereby discontinue the supply of fuel to the associated cocks and shut off, for example, 25% of the burners 3 in that zone.

If the temperature remains at a level above the preselected level of 450°, the sensor 20 will function to signal the controller 22 which, in turn, will further adjust the modulating motor 19 to reduce further the air pressure in the header 16, thereby downwardly further adjusting the volume of fuel passing into the venturi mixers 13 of the still-functioning burners 3. When the temperature within the zone is stabilized at, or about, the set point temperature of 450° the pressure in the header 16 also will stabilize and the fuel flow to the operating burners will maintain the set point temperature in the zone.

Should the set point temperature require a change, such as when the product to be baked is changed from one requiring greater heat to one requiring lesser heat, resetting of the set point temperature via the control module 22 while the zone temperature is at a level above the new set point, will effect adjustment of the valve 18 via the modulating motor 19 and reduce the gas flow through the header 16 to the venturi mixers 13, thereby shutting off additional burners 3 in the zone. If the new set point temperature is one corresponding to that attained when the pressure is at 14 inches of water column, the approach of the zone temperature will be sensed by the sensor 20 and the control module 22 will function to adjust the modulating motor 19 as required to enable the required number of burners 3 in the zone to reignite. As the zone temperature stabilizes, small temperature variations will be sensed by the sensor 20 and the modulating motor will function as aforesaid to control the combustion air header pressure and the supply of fuel to the burners.

The foregoing description has been concerned primarily with reductions in zone temperature. The apparatus also functions to accommodate increases in zone temperature, and in a manner which is the reverse of that described above.

The disclosed apparatus and methods are representative of presently preferred forms thereof, but are intended to be illustrative rather than definitive of the invention. The invention is defined in the claims.

I claim:

1. Apparatus for controlling the temperature within a selected zone of a baking oven having a housing through which a product to be baked may be conducted along a path and in which a plurality of spaced apart fuel burners are arranged, said apparatus including a source of combustion air under pressure; a source of fuel for each of said burners; means for combining fuel and combustion air from their respective sources and delivering combined combustion air and fuel to each of said burners; thermally sensitive means for sensing changes in temperature in said zone; and combustion air supply control means coupled to said thermally sensitive means and to the means for delivering combustion air to each of said burners for varying the pressure of combustion air delivered to said burners inversely according to changes in temperature sensed by said thermally sensitive means.

2. The apparatus according to claim 1 including fuel flow control means for controlling fuel flow from said source thereof to each of said burners, and combustion air pressure sensing means operatively coupled to said fuel flow control means for operating said fuel flow control means to enable and disable fuel flow to selected ones of said burners.

3. The apparatus according to claim 2 wherein said fuel flow control means comprises valve means movable between opened and closed positions, and means for moving said valve means between said positions in response to predetermined variations in said combustion air pressure.

4. The apparatus according to claim 1 wherein said combustion air supply control means includes valve means for adjusting the flow of combustion air to each of said burners.

5. The apparatus according to claim 4 wherein said combustion air supply control means is responsive to predetermined changes in the pressure of said combustion air to enable and disable the flow of fuel to said burners.

6. Apparatus for controlling the temperature within a selected zone of a baking oven having a housing through which a product to be baked may be conducted along a path and in which a plurality of spaced apart fuel burners are arranged, said apparatus comprising a source of fuel for said burners; a source of combustion air under pressure; means for combining and delivering a mixture of said fuel and said combustion air to said burners; means for adjusting the quantity of fuel delivered to said burners; means for adjusting the pressure of combustion air delivered to said burners; thermally sensitive means for sensing temperature changes in said zone; and combustion air pressure control means coupled to said thermally sensitive means and responsive to changes in temperatures sensed by said thermally responsive means to adjust the pressure of combustion air delivered to said burners inversely with respect to sensed temperature changes, whereby a reduction in combustion air pressure reduces the quantity of fuel supplied to said burners and an increase in combustion air pressure increases the quantity of fuel supplied to said burners.

7. A method of controlling the temperature within a selected zone of a baking oven having a housing through which a product to be baked may be conducted along a path and a plurality of spaced apart burners, said oven including for each of said burners a source of combustion air under pressure, a source of fuel, and means for combining combustion air and fuel, thermally sensitive means for sensing changes in temperature in said zone, and means for delivering fuel to said burners via said combustion air, said method comprising adjusting the pressure of said combustion air inversely according to changes in temperature sensed by said thermally sensitive means.

8. The method according to claim 7 including adjusting the quantity of fuel delivered to said burners in proportion to the adjustment of the pressure of said combustion air.

9. The method according to claim 7 including discontinuing the delivery of fuel to said burners in response to a predetermined reduction in the pressure of said combustion air.

10. The method according to claim 9 including reestablishing the delivery of fuel to said burners in response to a selected increase in the pressure of said combustion air.

11. A method of controlling the temperature within a zone of a baking oven having a plurality of spaced apart burners, a source of combustion air under pressure, a source of fuel, means for establishing a selected temperature in said zone, thermally sensitive means for sensing changes in temperatures in said zone, means for delivering combustion air and fuel to said burners, said method comprising establishing a predetermined pressure at which said combustion air is delivered to said burners, lighting a selected number of said burners to heat said zone; sensing changes in temperature in said zone; adjusting the pressure of said combustion air inversely to the changes in temperature in said zone; adjusting the fuel delivered to said burners in direct proportion to the adjustment of the pressure of said combustion air; and shutting off and relighting a selected number of said burners in response to the reduction below and the reestablishment of said combustion air pressure above said predetermined pressure.
